(19) United States
(12) Patent Application Publication
(10) Pub. No.: US 2007/0225879 A1
(43) Pub. Date: Sep. 27, 2007

(54) System and method for monitoring and managing an environment

(76) Inventors: John R. French, San Diego, CA (US); Joseph Nebolon, Del Mar, CA (US)

Correspondence Address: NYDEGGER & ASSOCIATES, 348 OLIVE STREET, SAN DIEGO, CA, 92103, US

(21) Appl. No.: 11/386,877

(22) Filed: Mar. 22, 2006

(51) Int. Cl. G01C 21/00

(52) U.S. Cl. 701/23; 701/207

(57) ABSTRACT

A network for monitoring and managing the occurrence of specified events in an environment requires a plurality of beacons. Specifically, the beacons are positioned at predetermined locations in the environment to emit respectively unique signals. Tags, with each tag having a distinctive identifier, are separately responsive to each beacon signal to generate a data record that is indicative of an interaction between the tag and a beacon signal. The data record is then transferred to a network control center for use in monitoring and managing the occurrence of specified events in the environment.

### FIELD OF THE INVENTION

The present invention pertains generally to electronic monitoring and event management systems. More particularly, the present invention pertains to systems and methods that electronically monitor the occurrence of specified events in a prescribed environment. The present invention is particularly, but not exclusively, useful for systems and methods that employ a plurality of beacons wherein each beacon individually and separately interacts with any one of a plurality of identifier tags to create a management record of the various interactions.

### BACKGROUND OF THE INVENTION

It is well known, and widely accepted, that an effective span of control is dependent on several, often disparate, factors. A common requirement for such control, however, is the ability to access meaningful information. And, to then use the information for managerial purposes. Obviously, the receipt of accurate, timely and pertinent information can be an invaluable management tool for any business or organization. In particular, this is so when multi-tasking is required. For instance, many profitable retail operations require that proper supervision be simultaneously provided for such diverse activities as: asset accountability, regulatory compliance, inventory control, consumer preferences and operational continuity. To be effective, all of these activities need to be coordinated and controlled.

With the above in mind, it is important to realize that any activity can be characterized, at least to some extent, by the occurrence of some event. Importantly, when these events can be specified, they can also be observed and monitored. For example, a specified event required for asset accountability may be the monitoring of the exact location of particular assets (e.g. shopping carts) within the business environment. On the other hand, the specified event for regulatory compliance may be the occurrence of some physical phenomenon that indicates a particular task (e.g. floor sweeping) has been timely performed. In the case of inventory control the specified event may be nothing more than an indication that a particular item of property (e.g. a tool) has been returned to its proper storage area. For more subjective activities, such as identifying consumer preferences, the loiter time or frequency of attendance at a particular location in a facility can be used as a specified event. Similarly, the monitoring of operational parameters (e.g. temperature or power output) can create specified events that are useful for ensuring the proper operation of equipment. In each of these examples, as well as many others, some specified event occurs that can be useful for monitoring and managing various activities in the environment.

In light of the above, it is an object of the present invention to provide a system and method for monitory multiple occurrences of specified events within an environment for the purpose of managing activities in the environment. Another object of the present invention is to provide a system and method for centralizing the acquisition of diverse activity indicators that can be used to collectively control activities in an environment. Yet another object of the present invention is to provide a system and method for monitoring and managing activities in an environment that is easy to implement, is simple to use, and is comparatively cost effective.

### SUMMARY OF THE INVENTION

In accordance with the present invention, a network for monitoring and managing the occurrence of specified events in an environment includes a plurality of beacons. Specifically, the beacons are strategically positioned at predetermined locations in the environment, and each beacon is programmed to emit a signal that is unique for the particular beacon. Further, the beacons are arrayed in the environment such that their signals respectively cover a predetermined area, or volume (i.e. space), of the environment. Though an overlap of beacon signals may be desirable for some purposes, it is generally preferable if they operate independently of one another. To the extent there is overlap, it is preferable if a beacon signal merely abuts the areas or volumes of adjacent beacons.

Along with the beacons, the system of the present invention also employs a plurality of tags. Specifically, each tag is programmed to have a distinctive identifier; and each tag interacts individually with each beacon in the system. Stated differently, each tag is separately responsive to the unique signal of each beacon. Consequently, whenever a tag enters the space of a beacon signal, and thereby interacts with the beacon, the unique signal of the particular beacon and the distinctive identifier of the particular tag will generate a data record that is indicative of a specified event. In particular, this data record may include information about the location of the beacon/tag interaction, the time and duration of the beacon/tag interaction, and whatever other special information may be required about the interaction. In some instances, the data record is immediately sent to a system integrator. In others, the data record can contain information about several different beacon/tag interactions for subsequent transmittal to the system integrator.

Depending on the information that is contained in the data record, several consequences can result. For one, the system integrator can transfer the data record to a network control center, where it can be used to create reports for monitoring and managing the occurrence of specified events in the environment. For another, the data record can trigger a response in the environment (e.g. a visual or audible alarm). In either case, as envisioned by the present invention, the system integrator may incorporate a web protocol for transferring the data record to the network control center via a landline connection or over the Internet.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic view of a portion of a system in accordance with the present invention when employed in an indoor environment, such as a retail store; and

FIG. 2 is a schematic view of a portion of a system in accordance with the present invention when employed in an outdoor environment, such as the parking lot and immediate environs of a retail store.

### DESCRIPTION OF THE PREFERRED EMBODIMENTS

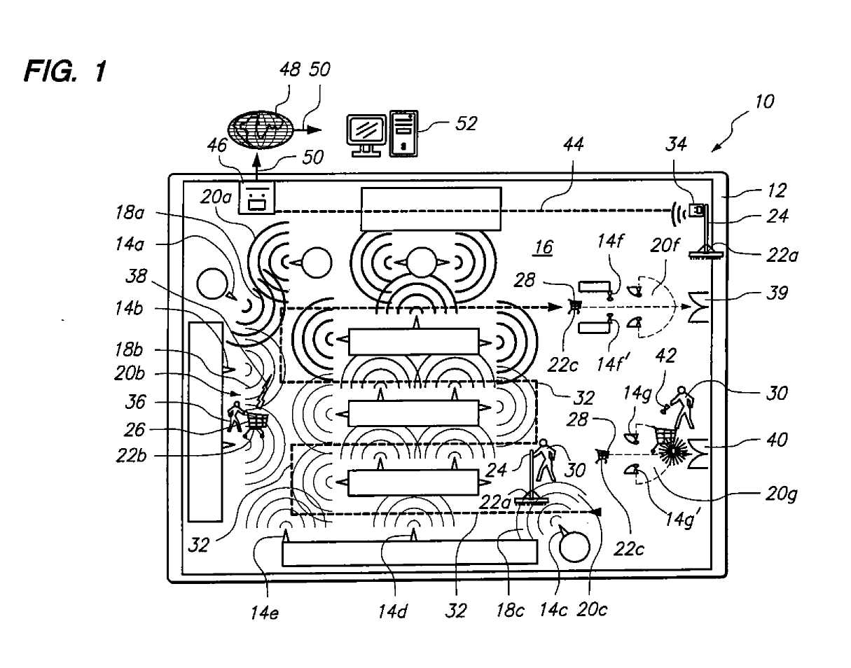

Referring initially to FIG. 1, a system (network) in accordance with the present invention is shown and is generally designated 10. As shown, the system (network) 10 can be set up and used inside an enclosure 12. For the present invention, the enclosure 12 can be any structure or building in which various activities, such as typically occur in a retail store, are to be monitored and managed. For these purposes, the system 10 includes a plurality of beacons 14 that are strategically located at different, predetermined locations in a defined environment 16. In FIG. 1, the environment 16 is taken to be all of the space within the enclosure 12. As will be appreciated by the skilled artisan, however, the environment 16 can be defined as being the entirety of space(s) that is(are) effectively serviced by the plurality of beacons 14.

In FIG. 1, several of the beacons 14 have been specifically identified as beacons 14 a-g. These designations are only exemplary, as many more beacons 14 can be employed, when necessary, depending on the specific requirements of the environment 16. Importantly, however, each beacon 14 will service a predetermined portion of the environment 16. For example, in the system 10, the beacon 14a will emit a signal 18a that is unique only to the particular beacon 14a. Further, the signal 18a will cover a space 20a that effectively corresponds to the radiation field of the signal 18a. Similarly, the beacons 14b and 14c emit their respective signals 18b and 18c into spaces 20b and 20c. Although the beacons 14a, b and c have been disclosed as being independently operated, the system (network) 10 also envisions cooperative beacons 14 that will operate with each other. For example, the cooperative beacons 14f and 14f′ are directional and emit their respective signals 18 into the space 20f.

As mentioned above, each beacon 14 emits a unique signal 18. More specifically, the unique signal 18 is programmed to identify the particular beacon 14 from which it was emitted. Further, since the exact location of each beacon 14 is known, and because the respective space 20 that is covered by its signal 18 can be established during the installation of the beacon 14, it is possible to accurately identify the location of an activity in the space 20. As intended for the present invention, various different activities are to be so identified.

An important aspect of the system (network) 10 that allows activities to be identified in the environment 16, is the use of tags 22. Specifically these tags 22 are used in a manner that will cause them to interact with the beacons 14 in the environment 16. Similar to the beacons 14, each tag 22 can be programmed to provide it with a distinctive identifier. Specifically, this distinctive identifier may not only identify the particular tag 22, it can also include operational or functional information about the object or piece of equipment to which it has been affixed. Also, and most importantly, each tag 22 will interact separately with each of the signals 18 as they are emitted from their respective beacons 14. Operationally, these interactions generate electronic data records that describe the involvement or interaction of a particular tag 22 with a particular beacon 14.

As intended for the present invention, the interaction of a tag 22 with the signal 18 from a particular beacon 14 is used as an indication that a specified event has occurred in the environment 16. More specifically, it is indicative that a specified event has occurred in the space 20 of a particular beacon 14. Accordingly, the data record that is generated by an interaction between a tag 22 and a beacon 14 will contain information about both the tag 22 and the beacon 14. The data record can also include information about the time, and the duration of the interaction. Additionally, for some applications, the data record can be used to trigger a response signal that will affect a consequent activity in the environment 16, such as an alarm or deactivation of a device.

Several examples of interactions between a tag 22 and a beacon 14 can be given with reference to FIG. 1. Specifically, FIG. 1 shows that a tag 22a has been affixed to a broom 24. Similarly, a tag 22b has been affixed to a shopping cart 26, and a tag 22c has been affixed to a shopping cart 28. First, consider the journey of a broom 24 as it moves through the environment 16. Whenever an employee 30 moves the broom 24 along a path 32, and through the aisles of the environment 16, the tag 22a that is on the broom 24 will sequentially interact with a plurality of beacons 14. To start, as shown, the tag 22a will interact with the signal 18c from beacon 14c. Next, the tag 22a will interact with the beacon 14d. The tag 22a will then interact with beacon 14e, and so on with other beacons 14 until the broom 24 has completed its travel along the path 32 and is returned to the base station 34. During this excursion, the tag 22a creates a different data record each time it interacts with a different beacon 14. These data records are then stored on the tag 22a for subsequent transmittal. With this example, it can be appreciated that the system 10 is useful for monitoring the completion of various tasks that may be required for regulatory compliance (e.g. sweeping the floor). Further, this example shows an application wherein the location of the broom 24 (e.g. in the vicinity of base station 34) can provide information for asset management/control purposes.

As another example of an interaction between a tag 22 and a beacon 14, consider the tag 22b when it is affixed to the shopping cart 26. As a customer 36 moves the shopping cart 26 through the environment 16, the tag 22b will interact with the signal 18b that is being emitted by the beacon 14b. Consequently, this interaction generates a data record that indicates when the tag 22b entered the space 20b, and the duration of its loiter time in the space 20b. This information can then be impressed on a wireless signal 38 and transmitted directly from the tag 22b (i.e. shopping cart 26), or from beacon 14b, to the base station 34 for subsequent use in helping determine such subjective evaluations as consumer preference.

For yet another example of an interaction between a tag 22 and a beacon 14, consider the tag 22c when it is affixed to the shopping cart 28. In this instance, FIG. 1 actually presents two depictions for consideration. The first involves an interaction of the shopping cart 28 with the beacons 14f and 14f′, while the second involves an interaction of the shopping cart 28 with beacons 14g and 14g′. Specifically, for the first interaction, the data record that is created will indicate the presence of the cart 28 as it passes through the space 20f and on its way out the exit 39 of the enclosure 12. No further action is taken. On the other hand, if the shopping cart 28 passes through the space 20g in an effort to leave the enclosure 12 through entrance 40, rather than going through space 20f and out the exit 39 as required, a data record is created by the interaction of tag 22c with the cooperative beacons 14g and 14g′ that will effect a mechanical response. Specifically, in this example, the data record activates internal controls on the shopping cart 28 that will cause a wheel of the shopping cart 28 to become locked. The shopping cart 28 cannot then be removed from the enclosure 12 until the shopping cart 28 has been reactivated. This will require attention from an employee 30, and the implementation of a controller 42 that is provided for that purpose. In both of these examples, like the example given above regarding tag 22b and cart 26, the data records can be transmitted to the base station 34 via respective wireless signals 38. These examples are given as instances wherein the system 10 can be used for asset accountability or inventory control purposes.

Still referring to FIG. 1, it will be recalled that in each of the examples given above, whenever a data record was generated by the interaction of a tag 22 with a beacon 14, it was somehow transferred or transmitted to the base station 34. FIG. 1 indicates that these data records are then transmitted via a line 44, or alternatively by a wireless signal 38, to a system integrator 46. The system integrator 46 will then collate and assemble the data records as required. These data records can then be transmitted off-site, via the Internet 48, as indicated by the arrows 50. Alternatively, the data records can be transmitted by any other means know in the pertinent art, such as by telephonic landline. Specifically, in each case the transmittal of these data records will go to a network control center 52. At the network control center 52, the data records can be evaluated and used for the preparation of reports that are useful for monitoring and managing activities within the environment 16. As envisioned for the present invention, the network control center 52 may be on-site or off-site, and may even be incorporated as part of the system integrator 46.

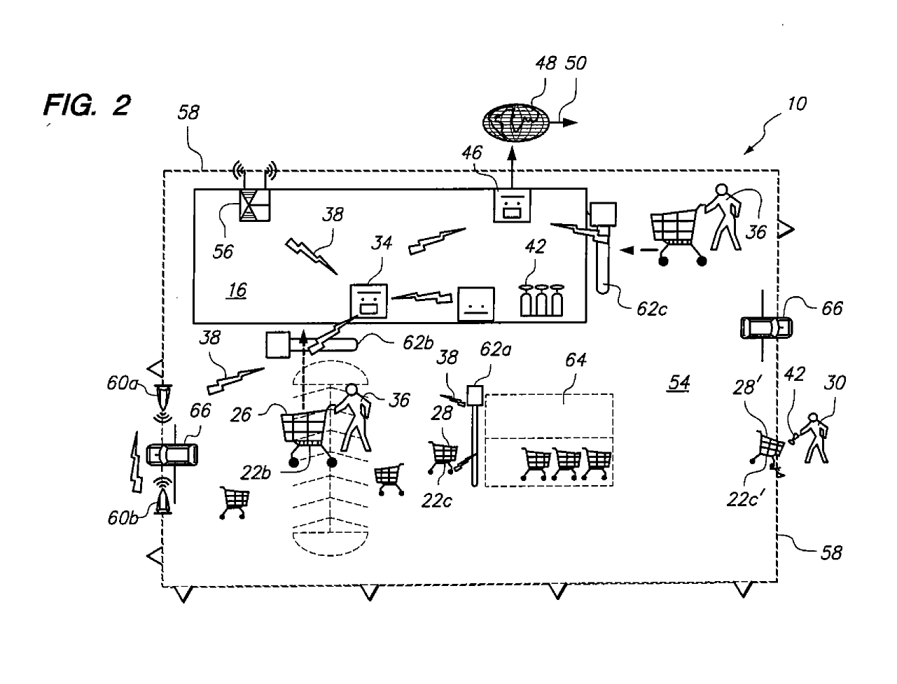

Referring now to FIG. 2, it will be seen that in addition to its use in an enclosed environment 16, the system (network) 10 can also be employed in an outdoor environment 54. In this application, one embodiment of the system 10 employs a transmitter 56 that is connected to a perimeter antenna 58. Preferably, the perimeter antenna 58 effectively surrounds the environment 54. This, however, may not be possible, or necessary. Therefore, to augment and complement the perimeter antenna 58, cooperative beacons, such as the beacons 60a and 60b shown in FIG. 2, can be employed wherever the positioning of the perimeter antenna 58 is not practical. In either case, the system 10 can be used for inventory management/control and asset accountability purposes.

As an example of an application of the system 10 in the outdoor environment 54, consider that the shopping cart 28 has successfully passed through the exit 39 of enclosure 12 (see FIG. 1). If the shopping cart 28 passes over the perimeter antenna 58, or passes between the beacons 60a and 60b, a specified event occurs. This can be transmitted via wireless signals 38 from the beacons 60a and 60b, or from the transmitter 56, to the base station 34, and then to the system integrator 46 in the manner disclosed above.

As indicated for the shopping cart 28′ in FIG. 2, the result of passing over the perimeter antenna 58, or between the beacons 60a and 60b, is a wheel lock up as also disclosed above. On the other hand, if the shopping cart 28 and its tag 22 pass through an electronic gate 62, a data record is generated, but no response is triggered, like those created by the interaction of a tag 22 with a beacon 14. For instance, the shopping cart 28 can pass through the gate 62a for a return of the cart 28 to the storage corral 64 without incident. Likewise, the shopping cart 28 can pass through the gate 62b or 62c and back into the environment 16, without incident. In each case, however, a data record is generated that will help track the location of the particular cart 28.

FIG. 2 also indicates that whenever a tag 22 is not involved, no data record will be generated. Specifically, the vehicle 66, which has no tag 22, can pass over the perimeter antenna 58, or through the beacons 60a and 60b, without incident. In accordance with the present invention, however, whenever a tag 22 interacts with a beacon 14, a perimeter antenna 58, a cooperative beacon 60a and 60b, or a gate 62, a data record is generated that is indicative of a specific event. These data records are then transmitted to the system integrator 46. In turn, the system integrator 46 transmits the data records to a network control center 52 where they are used to create reports that will be useful for monitoring and managing activities in the environment 16/54.

While the particular System and Method for Monitoring and Managing an Environment as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A network for monitoring and managing the occurrence of specified events in an environment which comprises:
a system integrator;
at least one beacon positioned at a predetermined location in the environment, wherein the particular beacon emits a unique signal;
a tag having a distinctive identifier, wherein the tag is separately responsive to the unique signal of the beacon to generate a data record whenever the tag interacts with the unique signal of a particular beacon;
a means for transmitting the data record to the system integrator; and
a means incorporated into the system integrator for transferring the data record to a network control center for use in monitoring and managing the occurrence of specified events in the environment.

2. A network as recited in claim 1 wherein each beacon emits its unique signal into a respective space, and the data record is generated when the tag with distinctive identifier enters the unique space of a particular beacon.

3. A network as recited in claim 2 wherein there is a plurality of tags, and at least one tag is mounted on an object for movement through the environment.

4. A network as recited in claim 3 wherein the object is a shopping cart having a wheel, and further wherein the data record initiates a response signal for locking the wheel of the shopping cart.

5. A network as recited in claim 1 wherein the distinctive identifier of the tag is programmable.

6. A network as recited in claim 1 wherein the unique signal of each beacon is programmable.

7. A network as recited in claim 1 further comprising a web protocol incorporated in the system integrator for transferring the data record to the network control center via a connection over the Internet.

8. A network as recited in claim 1 further comprising a means at the network control center for creating a report based on data records received by the network control center.

9. A network as recited in claim 8 wherein the report is used for an inventory control purpose.

10. A network for monitoring and managing the occurrence of specified events in an environment which comprises:
a means for generating a plurality of unique signals, wherein each unique signal is emitted into a predetermined portion of the environment;
a means for separately interacting with each unique signal to generate a respective data record indicative of the occurrence of a specified event; and
a means for receiving the data records as they are generated in real time for use in monitoring and managing the occurrence of specified events in the environment.

11. A network as recited in claim 10 wherein the generating means is a plurality of beacons positioned at predetermined locations in the environment.

12. A network as recited in claim 11 wherein the interacting means is a plurality of tags, with each tag having a distinctive identifier.

13. A network as recited in claim 12 wherein the receiving means is a network control center.

14. A network as recited in claim 13 further comprising a system integrator having a web protocol for transferring the data records to the network control center via a connection over the Internet.

15. A network as recited in claim 12 wherein each beacon emits its unique signal into a respective space, and the data record is generated when the tag with distinctive identifier enters the unique space of a particular beacon.

16. A network as recited in claim 15 wherein the data record includes information about the time duration the tag remains in the unique space of a particular beacon.

17. A method for monitoring and managing the occurrence of specified events in an environment which comprises the steps of:
positioning at least one beacon at a predetermined location in the environment, wherein each particular beacon emits a unique signal;
providing at least one tag, wherein each tag has a distinctive identifier, and wherein each tag is separately responsive to the unique signal of each beacon to generate a data record whenever the tag interacts with the unique signal of a particular beacon; and
transmitting the data record to the system integrator for subsequent use in monitoring and managing the occurrence of specified events in the environment.

18. A method as recited in claim 17 further comprising the steps of:
programming the unique signal for each beacon; and
programming the distinctive identifier for each tag.

19. A method as recited in claim 18 wherein the transmitting step includes incorporating a web protocol in the system integrator for transferring the data record to the network control center via a connection over the Internet.

20. A method as recited in claim 19 further comprising the step of creating a report based on data records received by the network control center.
